(19) United States
(12) Patent Application Publication
(10) Pub. No.: US 2015/0040666 A1
(43) Pub. Date: Feb. 12, 2015

(54) SENSOR UNIT, ELECTRONIC APPARATUS, AND MOVING OBJECT

(71) Applicant: Seiko Epson Corporation, Tokyo (JP)

(72) Inventors: Yoshikuni SAITO, Suwa (JP); Yusuke KINOSHITA, Minowa (JP); Yoshihiro KOBAYASHI, Komagane (JP); Masayasu SAKUMA, Shiojiri (JP)

(21) Appl. No.: 14/448,122

(22) Filed: Jul. 31, 2014

(30) Foreign Application Priority Data
Aug. 9, 2013 (JP) 2013-166008

(51) Int. Cl. G01P 15/02

(52) U.S. Cl. CPC G01P 15/02
USPC 73/514.01

(57) ABSTRACT

A sensor unit includes a substrate provided with a first sensor device as an inertia sensor and a connector connected to the first sensor device, and a mount on which the substrate is placed and which includes an opening through which the connector is exposed. A gap is provided between the substrate and the mount, and the first sensor device is provided in a position that falls within the gap in a plan view.

### BACKGROUND

1. Technical Field

The present invention relates to a sensor unit, and an electronic apparatus and a moving object including the same.

2. Related Art

There is a known sensor module, such as that disclosed in JP-A-2013-198826, in which electronic parts, such as an inertia sensor, for example, a vibration-type angular velocity sensor that vibrates a driver and an acceleration sensor including a movable body, and a connector, are mounted on a circuit substrate supported by a mount and the circuit substrate and the electronic parts are covered with a lid member. In the sensor module, the connector is exposed through an opening provided in a side surface of the lid member. The sensor module is electrically connected to an implementation substrate (control circuit) in an electronic apparatus that incorporates the sensor module via a connection member, such as a cable or a flexible wiring substrate extending from the connector to which the connection member is fit.

In the configuration described above, however, the electrical connection between the implementation substrate of the electronic apparatus and the sensor module is made by using a connection member, such as a cable or a flexible wiring substrate extending from the connector to which the connection member is fit. The connection member has a portion that extends from the connector and resonates at a resonance frequency. When vibration at a frequency close to the resonance frequency is applied to the connection member, the connection member resonates and the vibration is amplified and propagates through the connector to the circuit substrate and the inertia sensor. Specifically, the vibration may propagate to the driver in the vibration-type angular velocity sensor or the movable body in the acceleration sensor and undesirably affect detection and output characteristics of the inertia sensor.

### SUMMARY

An advantage of some aspects of the invention is to solve at least a part of the problems described above, and the invention can be implemented as the following forms or application examples.

### Application Example 1

A sensor unit according to this application example includes a substrate provided with an inertia sensor and a connector connected to the inertia sensor and a mount on which the substrate is placed and which includes an opening through which the connector is exposed. A gap is provided between the substrate and the mount, and the inertia sensor is provided in a position that falls within the gap in a plan view.

According to this application example, since the connector is exposed through the opening of the mount, a connector on an implementation substrate to which the sensor unit is connected can be directly connected to the connector of the sensor unit. As a result, wiring lines, a flexible wiring substrate, or any other component used in related art is not required, and no resonance phenomenon of such wiring lines or a flexible wiring substrate will propagate through the substrate in the sensor unit to the inertia sensor or affect characteristics of the inertia sensor. Further, since the inertia sensor is disposed in a position that falls within the gap provided between the mount and the substrate, the inertia sensor is unlikely to receive variation in stress (such as thermal distortion, vibration, and impact) that occurs in the mount. The sensor unit in this application example can therefore perform more stable measurement under a condition where resonance oscillation, stress variation, and other types of external influence are suppressed.

### Application Example 2

In the sensor unit according to the application example described above, it is preferable that the substrate has a mount-joint area that is boned to the mount and a non-mount-joint area that overlaps with the gap in a plan view, and that the inertia sensor is disposed in the non-mount-joint area.

According to this application example, since the inertia sensor is disposed in the non-mount-joint area, which overlaps in a plan view with the gap where the substrate is not bonded to the mount, variation in stress (such as thermal distortion, vibration, and impact) that occurs in the mount is unlikely to propagate to the inertia sensor. The sensor unit can therefore perform more stable measurement under a condition where resonance oscillation, stress variation, and other types of external influence on the measurement performed by the inertia sensor are suppressed.

### Application Example 3

In the sensor unit according to the application example described above, it is preferable that the mount-joint area of the substrate is provided in a portion around the opening.

According to this application example, since the mount-joint area, where the substrate is bonded to the mount, is provided in a portion around the connector, the amount of bending of the portion of the substrate to which the connector is connected and a portion of the substrate therearound decreases, whereby the connector can be attached and detached to and from the substrate in a more smooth, reliably manner.

### Application Example 4

In the sensor unit according to the application example described above, it is preferable that a filler is provided in a portion between an outer circumferential portion of the connector and a circumferential edge of the opening.

According to this application example, the filler provided in a portion between an outer circumferential portion of the connector and a circumferential edge of the opening blocks an open portion between the outer circumferential portion of the connector and the circumferential edge of the opening, whereby no moisture, dust, or other foreign matter is allowed to pass through the open portion.

### Application Example 5

In the sensor unit according to the application example described above, it is preferable that an input/output surface of the connector is positioned inside the mount.

According to this application example, the connector does not protrude from a surface of the mount, specifically, a surface thereof facing away from the surface of the mount to which the substrate is connected, that is, the surface of the mount that faces the implementation substrate. The configuration prevents the connector from being broken even when an unexpected event occurs.

### Application Example 6

It is preferable that the sensor unit according to the application example described above further includes a lid member covering the substrate, and the lid member is preferably connected to the mount.

According to this application example, since the lid member is connected to the mount, the lid member can protect the inertia sensor, the connector, and other parts connected to and mounted on the substrate. The lid member can further prevent moisture, dust, or other foreign matter from entering the sensor unit, whereby the reliability of the sensor unit can be improved.

### Application Example 7

An electronic apparatus according to this application example includes the sensor unit according to any one of the application examples described above.

According to this application example, an electronic apparatus having higher reliability can be provided because it includes the sensor unit capable of performing more stable measurement under a condition where resonance oscillation, stress variation, and other types of external influence on the inertia sensor are suppressed.

### Application Example 8

A moving object according to this application example includes the sensor unit according to any one of the application examples described above.

According to this application example, a moving object having higher reliability can be provided because it includes the sensor unit capable of performing more stable measurement under a condition where resonance oscillation, stress variation, and other types of external influence on the inertia sensor are suppressed.

### BRIEF DESCRIPTION OF THE DRAWINGS

The invention will be described with reference to the accompanying drawings, wherein like numbers reference like elements.

FIGS. 1A to 1C show a schematic configuration of a sensor unit according to an embodiment. FIG. 1A is a plan view. FIG. 1B is a front cross-sectional view. FIG. 1C is a bottom view.

FIG. 2 is a front cross-sectional view showing an example of implementation of the sensor unit.

FIGS. 3A and 3B show a schematic configuration of a variation of the sensor unit. FIG. 3A is a plan view, and FIG. 3B is a front cross-sectional view.

FIG. 4 is a block diagram schematically showing the configuration of an electronic apparatus according to an embodiment.

FIG. 5 is a block diagram schematically showing the configuration of a moving object according to an embodiment.

FIG. 6 is a block diagram schematically showing the configuration of a machine according to an embodiment.

### DESCRIPTION OF EXEMPLARY EMBODIMENTS

### Embodiment

An embodiment of the invention will be described below with reference to the accompanying drawings.

### Configuration of Sensor Unit

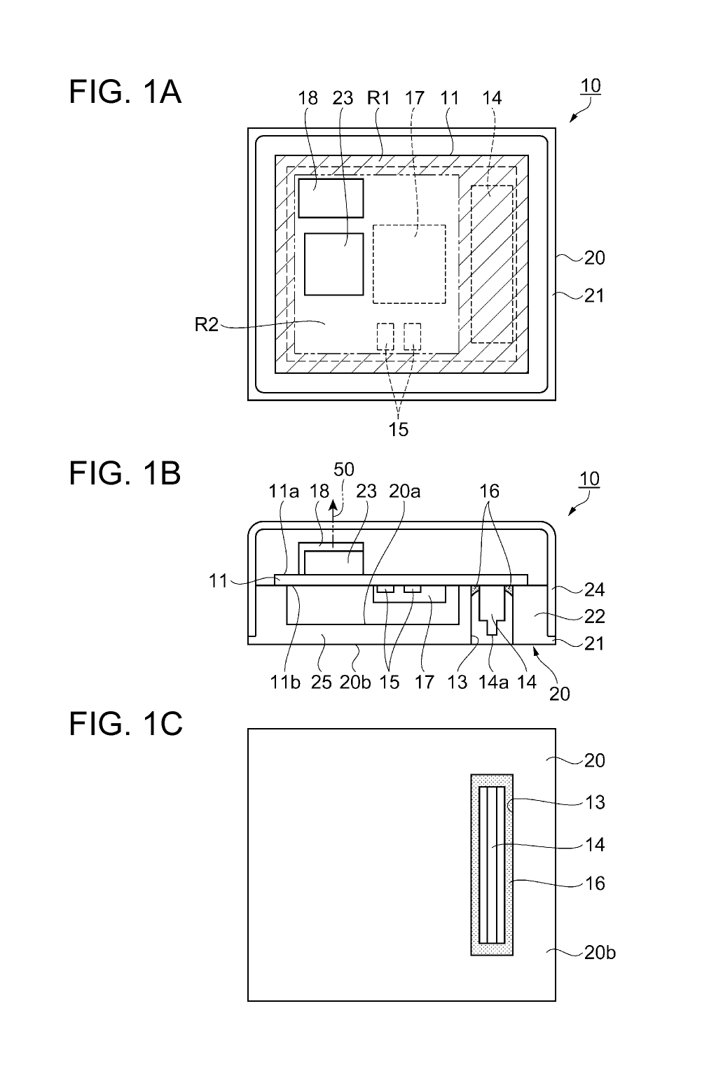

FIGS. 1A to 1C schematically show the exterior appearance of a sensor unit according to the embodiment. FIG. 1A is a plan view. FIG. 1B is a front cross-sectional view. FIG. 1C is a bottom view. In FIG. 1A, a cap that serves as a lid member is omitted for ease of illustration.

A sensor unit 10 includes a substrate 11, on which a first sensor device 23 as an inertia sensor and a connector 14 connected to the first sensor device 23 are provided, and a mount 20, on which the substrate 11 is placed and which has an opening 13, through which the connector 14 is exposed, as shown in FIGS. 1A to 1C. The sensor unit 10 further includes a cap 24, which serves as a lid member that is connected to the mount 20 and covers the substrate 11. The first sensor device 23 is disposed in a portion (non-mount-joint area R2, which will be described later) that overlaps in a plan view with a gap provided between the substrate 11 and the mount 20. The constituent members of the sensor unit 10 along with other constituent members will be described below in detail.

### Substrate

The substrate 11 has principal surfaces provided on the front and rear sides thereof and has a first surface 11a, which is one of the principal surfaces, and a second surface 11b, which is the other principal surface on the rear side facing away from the first surface 11a on the front side. The substrate 11 has a mount-joint area R1 (hatched area in FIG. 1A), which is an area connected to the mount 20, which will be described later, and a non-mount-joint area R2, which is an area that overlaps in a plan view with a gap provided between the substrate 11 and the mount 20 connected thereto, that is, an area excluding the mount-joint area R1. The substrate 11 is formed of an insulator made, for example, of a resin or ceramic material. A wiring pattern (implementation wiring lines and electrodes) made of an electrically conductive material and formed, for example, in a plating film deposition process is formed on each of the first surface 11a and the second surface 11b of the substrate 11 but is not shown in FIGS. 1A to 1C.

The first sensor device 23 as an inertial sensor and a second sensor device 18 are implemented on the first surface 11a in the non-mount-joint area R2 of the substrate 11. The first sensor device 23 has a flat box-like external shape formed of external surfaces each having a rectangular contour. The first sensor device 23 has a plurality of external electrodes (not shown) provided on one of the external surfaces. The first sensor device 23 is so disposed in the non-mount-joint area R2 that the bottom surface of the first sensor device 23 is in contact with the first surface 11a of the substrate 11 and is so implemented that the first sensor device 23 is electrically connected to electrodes provided on the substrate 11. The connection in the implementation process is made by using a bonding material, such as a solder material. The first sensor device 23 is formed of an angular velocity sensor having a single detection axis 50, that is, a gyro sensor. The angular velocity sensor, in which the detection axis 50 is perpendicular to the bottom surface of the sensor, detects an angular velocity around the detection axis 50. In the present example, a configuration in which a single first sensor device 23 is used as an angular velocity sensor is presented by way of example. Instead, a configuration in which a plurality of sensor devices each of which is similar to the first sensor device 23 are used to detect angular velocities around multiple detection axes may be employed. For example, to detect angular velocities around three axes perpendicular to each other, respective sensor devices are so implemented on the substrate 11 that the bottom surfaces of the sensor devices are oriented in the directions of the three axes perpendicular to each other.

The second sensor device 18 is formed, for example, of an acceleration sensor. In the present example, the second sensor device 18 is a sensor capable of detecting acceleration along a single axis (detection axis 50) by way of example and can detect acceleration along the detection axis 50. The second sensor device 18 may instead be formed, for example, of a three-axis acceleration sensor capable of detecting acceleration along multiple axes. Using such a three-axis acceleration sensor allows detection of acceleration along three axes perpendicular to each other.

On the second surface 11b, which is one of the principal surfaces of the substrate 11 and faces away from the first surface 11a, are implemented the connector 14, other electronic parts 15, such as a chip resistor and a chip capacitor, an IC chip (electronic circuit) 17, and other components. Connection between the second surface 11b and the components described above in the implementation process is made by using a bonding material, such as a solder material. The chip resistor or the chip capacitor may be used to improve characteristics of an output from each of the sensor devices. The connector 14, the other electronic parts 15, the IC chip (electronic circuit) 17, and other components are electrically connected to each other via the wiring pattern (not shown). The connector 14 is so disposed that the bottom surface (fixing surface) thereof is in contact with the second surface of the substrate 11 and is attached to the second surface 11b of the substrate 11. The thus attached connector 14 allows the direction in which the detection axis 50 of the first sensor device 23 extends to be aligned with the direction in which the connector 14 is inserted with the substrate 11 present between the first sensor device 23 and the connector 14.

The above description has been made with reference to the case where the first sensor device 23 and the second sensor device 18 are implemented on the first surface 11a of the substrate 11 and the connector 14, the electronic parts 15, the IC chip (electronic circuit) 17, and other components are implemented on the second surface 11b of the substrate 11, but specific components are not necessarily implemented on a specific surface of the substrate or a specific combination of components to be implemented is not necessarily employed. For example, the electronic parts 15, the IC chip (electronic circuit) 17, and other components may be implemented on the first surface 11a, and the connector 14, the first sensor device 23, the second sensor device 18, and other components may be implemented on the second surface 11b.

### Mount

The mount 20 is so provided that it faces the second surface 11b of the substrate 11. The mount 20 has a plate-shaped base 25, which is so provided that it faces the second surface 11b of the substrate 11, a protruding portion 22, which has an annual shape and protrudes from the base 25 toward the second surface 11b along the outer circumference of the base 25, and a flange 21, which has a small thickness and is provided along the outer circumferential edge of the base 25. The base 25 has an upper surface 20a and a lower surface 20b, which is a rear surface facing away from a front surface or the upper surface 20a. The protruding portion 22 has a through hole 13 provided therein, and the through hole 13 passes through the mount 20 from the lower surface 20b thereof to the surface thereof where the mount 20 is bonded to the substrate 11. The through hole 13 accommodates the connector 14 connected to the substrate 11 when the substrate 11 is connected to the mount 20 as described later. The through hole 13 has a shape slightly larger than the external shape of the connector 14. The through hole 13 in the present example is a hole having a rectangular opening.

In the mount-joint area R1 including an outer circumferential portion of the substrate 11 and an outer circumferential portion of the connector 14, the substrate 11 is supported by the mount 20 when the substrate 11 is connected to the protruding portion 22. How to connect the substrate 11 is not limited to a specific method, and adhesive-based connection, screw-based fixation, or any other method can be used. Both adhesive-based fixation and screwing are preferably used to reliably fix the substrate 11 to the protruding portion 22. Further, in this case, since an adhesive layer is present between the mount 20 and the substrate 11, the adhesive absorbs and reduces vibration from the mount 20, whereby undesirable vibration of the substrate 11 is suppressed. As a result, detection precision of the sensor unit 10 is further improved. The protruding portion 22 has an annular shape and protrudes toward the second surface 11b in the above description but is not necessarily shaped as described above. For example, a plurality of protrusions protruding toward the second surface may be arranged along the annular area. Since the substrate 11 is bonded to the mount 20 also in an area around the connector 14, the portion of the substrate 11 to which the connector 14 is connected and a portion of the substrate 11 therearound are unlikely to bend, whereby the connector 14 can be attached and detached to and from the substrate 11 in a more smooth, reliably manner.

The height of the protruding portion 22 with respect to the upper surface 20a is so set that an input/output surface 14a of the connector 14 is accommodated in the through hole 13 when the substrate 11 is connected to the protruding portion 22. In other words, when the substrate is connected to the protruding portion 22, the input/output surface 14a of the connector 14 is located in a position inside the lower surface 20b of the base 25 (lower surface of mount 20) (shifted toward upper surface 20a). The configuration described above prevents an impact or load from acting on the connector 14 even when an unexpected event occurs and hence prevents the connector 14 from being broken. A filler 16 is disposed in a gap between the inner circumference of the through hole 13 and the outer circumference of the connector 14. Filling the gap with the filler 16 blocks the opening connected to the lower surface of the mount 20 (lower surface 20b of base 25), whereby no moisture, dust, or other foreign matter is allowed to pass through the lower surface of the mount 20.

The thus configured mount 20 can readily support the substrate 11 and provide a space that accommodates the connector 14, the other electronic parts 15, such as a chip resistor and a chip capacitor, the IC chip (electronic circuit) 17, and other components between the substrate 11 and the base 25. When the substrate 11 is thus fixed, a space is formed between the substrate 11 and the base 25 and can accommodate the connector 14, the electronic parts 15, the IC chip (electronic circuit) 17, and other components. The space prevents the parts accommodated therein from coming into contact with the mount 20, whereby the reliability of the sensor unit 10 is improved. Further, the cap 24, which serves as a lid member and will be described later, is bonded to the flange 21. The cap 24 can be readily bonded to the mount 20, for example, by using a resin adhesive primarily made, for example, of an epoxy resin.

The thus configured mount 20 is not necessarily made of a specific material but is preferably made of a vibration damping material, which suppresses undesirable vibration of the substrate 11, whereby the first sensor device 23, the second sensor device 18, and other sensor devices can perform detection with improved precision. Examples of the vibration damping material may include a magnesium alloy, an iron-based alloy, a copper alloy, a manganese alloy, an Ni—Ti-based alloy, and a variety of other vibration damping alloys.

### Lid Member

The cap 24 as a lid member has a box-like shape and is so fixed to the mount 20, specifically, to the flange 21 that the cap 24 covers the substrate 11. The cap 24 has a substantially rectangular opening that conforms to the flange 21 of the mount 20, is so disposed that the opening faces the mount 20, and is bonded to the mount 20, for example, with a resin adhesive. The cap 24 may instead be connected to the mount 20 with screws.

The thus configured cap 24 is not necessarily made of a specific material and is made, for example, of polyethylene, polypropylene, ethylene-propylene copolymer, or any other polyolefin, polyvinyl chloride, polystyrene, polyamide, polyimide, polycarbonate, poly-(4-methylpentene-1), ionomer, acrylic-based resin, polymethyl methacrylate, acrylonitrile butadiene styrene copolymer (ABS), acrylonitrile-styrene copolymer (AS resin), styrene-butadiene copolymer, polyethylene terephthalate (PET), polybutylene terephthalate (PBT), or any other polyester, polyether, polyether-ketone (PEK), polyether ether ketone (PEEK), polyether-imide, polyacetal (POM), polyphenylene oxide, polysulfone, polyether sulphone, polyphenylene sulfide, polyallylate, aromatic polyester (liquid crystal polymer), polytetrafluoroethylene, polyvinylidene fluoride, or any other fluorine-based resin, epoxy resin, phenolic resin, urea resin, melamine resin, silicone resin, polyurethane, or copolymers, blended structures, or polymer alloys primarily made of any of the materials described above, and one or more of the above materials may be combined with each other to form the cap 24. Further, the cap 24 can be formed of a thin plate made, for example, of aluminum, stainless steel, iron-based alloy, or copper-based alloy, followed by surface treatment and press formation.

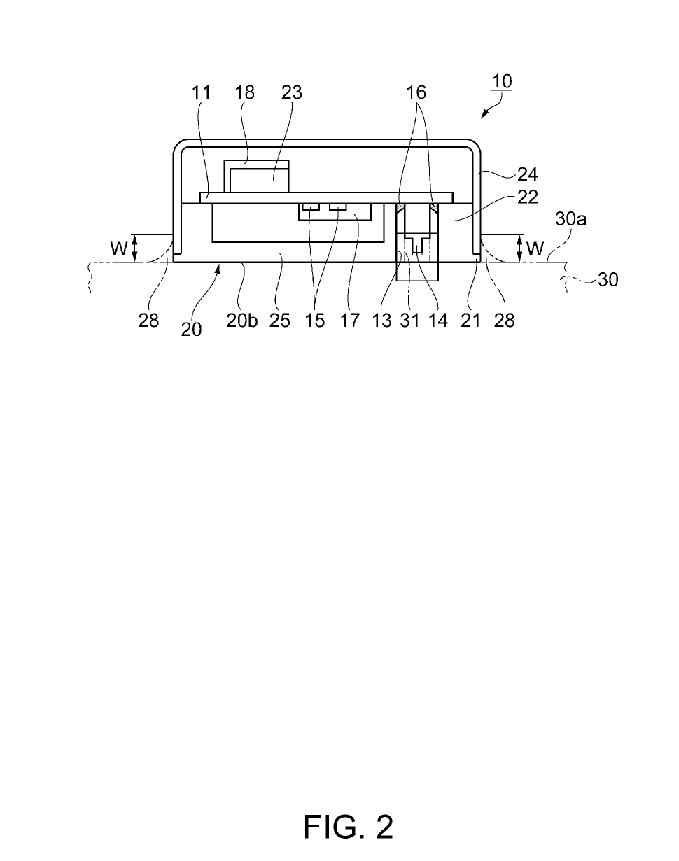

A configuration in which the sensor unit 10 described above is implemented on an implementation substrate will be described with reference to FIG. 2. FIG. 2 is a front cross-sectional view showing an example of the implementation of the sensor unit. In FIG. 2, the same components as those in the embodiment described above have the same reference characters, and components associated with the implementation substrate are drawn with chain double-dashed lines. Further, the same components as those in the embodiment described above will not be described.

The sensor unit 10 is so disposed and connected that the connector 14 (male connector) is inserted into a connector 31 (female connector) on an implementation substrate 30 and the lower surface 20b of the mount 20 is in contact with an upper surface 30a of the implementation substrate 30, as shown in FIG. 2. The connector 14 of the sensor unit 10 is thus directly connected to the connector 31 on the implementation substrate 30. The description has been made with reference to the case where the connector 14 is a male connector and the connector 31 is a female connector, but the connector configurations may be reversed, that is, the connector 14 may be a female connector and the connector 31 may be a male connector.

A lower portion of the outer circumference of the sensor unit 10 (region indicated by reference character W in FIG. 2) may be bonded to the implementation substrate 30, for example, with an adhesive 28. The bonding operation allows more secure bonding of the sensor unit 10 to the implementation substrate 30. The adhesive 28 may instead be placed between the bottom surface of the sensor unit 10 (lower surface 20b of base 25 of mount 20) and the implementation substrate 30. The adhesive 28, when applied to the lower portion around the entire outer circumference of the sensor unit 10, provides a sealing effect. Applying the adhesive 28 to the lower portion around the entire outer circumference of the sensor unit 10 prevents foreign matter from entering through the through hole 13 formed through the bottom surface of the sensor unit 10 (lower surface 20b of base 25 of mount 20).

Further, a surface of the cap 24, specifically, the surface thereof located in the lower portion of the outer circumference of the sensor unit 10 (region indicated by reference character W in FIG. 2) is preferably so treated that the adhesive 28 has improved wettability. An example of the treatment can be roughening (MAT treatment, for example) of the surface of the cap 24 in a honing or etching process. When the cap 24 is made of aluminum, alumite treatment can be performed on a region except the region indicated by reference character W in FIG. 2 and no alumite treatment is performed on the region indicated by reference character W in FIG. 2. The region indicated by reference character W preferably has a size of about 1 mm measured from the end of the opening of the cap 24.

The treatment of the lower portion of the outer circumference of the sensor unit 10 (region indicated by reference character W in FIG. 2) as described above allows the adhesive 28 in the region indicated by reference character W in FIG. 2 to have improved wettability, whereby the adhesive can be reliably applied. Further, the treatment prevents the adhesive 28 from flowing out of the region indicated by reference character W in FIG. 2. A steady amount of adhesive 28 can therefore be applied, whereby the sealing effect can be more reliably provided.

According to the sensor unit 10 described above, since the connector 14 is exposed through the through hole 13 as an opening of the mount 20, the connector 31 on the implementation substrate 30, to which the sensor unit 10 is connected, can be directly connected to the connector 14 of the sensor unit 10. As a result, wiring lines, a flexible wiring substrate, or any other component used in related art is not required, and no resonance phenomenon of such wiring lines or a flexible wiring substrate will propagate through the substrate 11 to the first sensor device 23 as an inertia sensor or affect characteristics of the first sensor device 23. Further, since the first sensor device 23 is connected to the substrate 11 in the non-mount-joint area R2, which is not the mount-joint area R1, where the substrate 11 is connected to the mount 20, variation in stress (such as thermal distortion, vibration, and impact) that occurs in the mount 20 is unlikely to propagate to the first sensor device 23. The sensor unit 10 in the present example can therefore perform more stable measurement under a condition where resonance oscillation, stress variation, and other types of external influence are suppressed.

### Variation of Sensor Unit

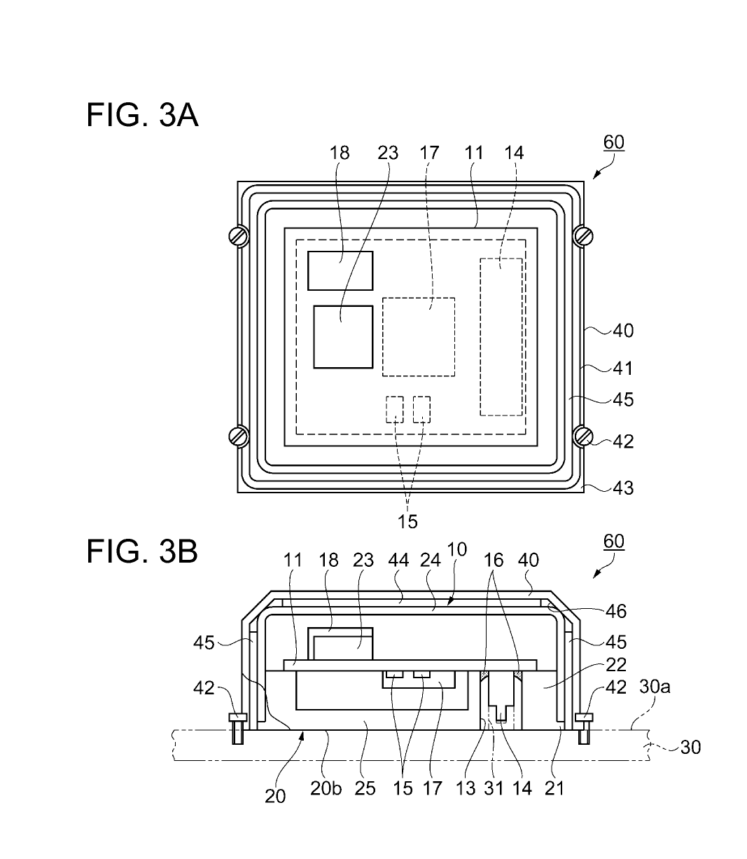

A variation of the sensor unit will next be described with reference to FIGS. 3A and 3B. FIGS. 3A and 3B show a schematic configuration of the variation of the sensor unit. FIG. 3A is a plan view, and FIG. 3B is a front cross-sectional view. In FIGS. 3A and 3B, the same components as those in the embodiment described above have the same reference characters. The same components will not be described in some cases.

A sensor unit 60 according to the variation shown in FIGS. 3A and 3B has a configuration in which a fixture 40 for fixing the sensor unit 10 described in the above embodiment to the implementation substrate 30 is provided in a position outside the sensor unit 10. The sensor unit 60 according to the variation will be described below in detail, but the configuration of the sensor unit 10 will not be described because it has been already described and components different from those in the sensor unit 10 will be described.

The fixture 40 has a recessed shape that opens through one side and can accommodate the sensor unit 10. A flange 43, which protrudes from an outer surface 41, is provided along the edge of the opening. The flange 43 has a fixing portion including four cutouts and flattened portions, and screws 42 are inserted through the fixing portion for fastening. The fixture 40 can be formed, for example, by using a method in which aluminum, stainless steel, iron-based alloy, copper-based alloy, or any other metal material is shaped in a press forming process or a method in which a resin material is shaped in a resin molding process. The fixture 40 has an inclined portion where the side surface is connected to the upper surface facing away from the opening. An inner surface 46 of the inclined portion comes into contact with a rounded corner portion (fillet portion) of the cap 24 of the sensor unit 10, whereby the sensor unit 10 can be readily positioned in the in-plane direction and the upward/downward direction.

Further, buffer members 44 and 45 are provided in a gap between the fixture 40 and the sensor unit 10. The buffer members 44 and 45 prevent an external impact from transmitting to the sensor unit 10. The size of the gap between the fixture 40 and the sensor unit 10 is preferably set at about 1 mm. The buffer members 44 and 45 may instead be omitted. As described above, the sensor unit 60 is so fixed to the implementation substrate 30 that the fixture 40, which covers the accommodated sensor unit 10 and is fixed to the implementation substrate 30 with the four screws 42, positions the sensor unit 10 in the in-plane direction and the upward/downward direction and provides the impact buffering effect.

According to the sensor unit 60 of the variation described above, the impact buffering effect that protects the accommodated sensor unit 10 is provided, and the sensor unit 10 can be readily positioned in the in-plane direction and the upward/downward direction and fixed to the implementation substrate 30.

### Application Examples of Sensor Unit

The sensor units 10 and 60 described above can be used in an electronic apparatus, a moving object, and other machines. Exemplary configurations using the sensor unit 10 will be presented and described below in detail.

### Electronic Apparatus

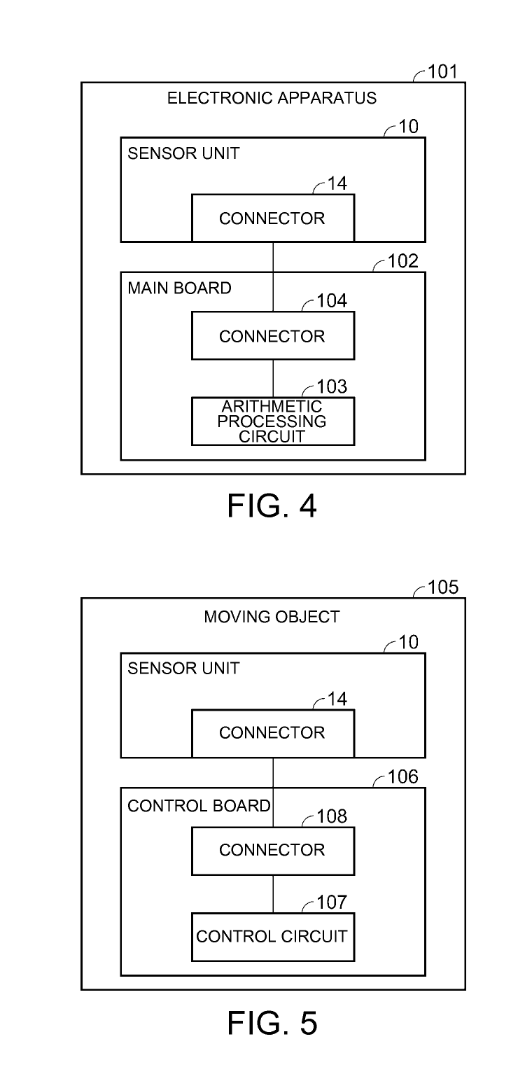

The sensor unit 10 described above can, for example, be used as a component incorporated in an electronic apparatus 101, as shown in FIG. 4. In the electronic apparatus 101, for example, an arithmetic processing circuit 103 and a connector 104 are implemented on a main board (implementation substrate) 102. The connector 14 of the sensor unit 10, for example, can be coupled to the connector 104. A detection signal from the sensor unit 10 can be supplied to the arithmetic processing circuit 103. The arithmetic processing circuit 103 processes the detection signal from the sensor unit 10 and outputs a result of the processing. The electronic apparatus 101 can, for example, be a motion sensing unit, a consumer game console, a motion analyzer, a surgical navigation system, and an automobile navigation system.

### Moving Object

The sensor unit 10 can be used, for example, as a component incorporated in a moving object 105, as shown in FIG. 5. In the moving object 105, for example, a control circuit 107 and a connector 108 are implemented on a control board (implementation substrate) 106. The connector 14 of the sensor unit 10, for example, can be coupled to the connector 108. A detection signal from the sensor unit 10 can be supplied to the control circuit 107. The control circuit 107 can process the detection signal from the sensor unit 10 and control the motion of the moving object 105 in accordance with a result of the processing. Examples of the control may include moving object behavior control, automobile navigation control, automobile airbag activation control, inertia navigation control in an airplane or a ship, and guidance control.

### Other Machines

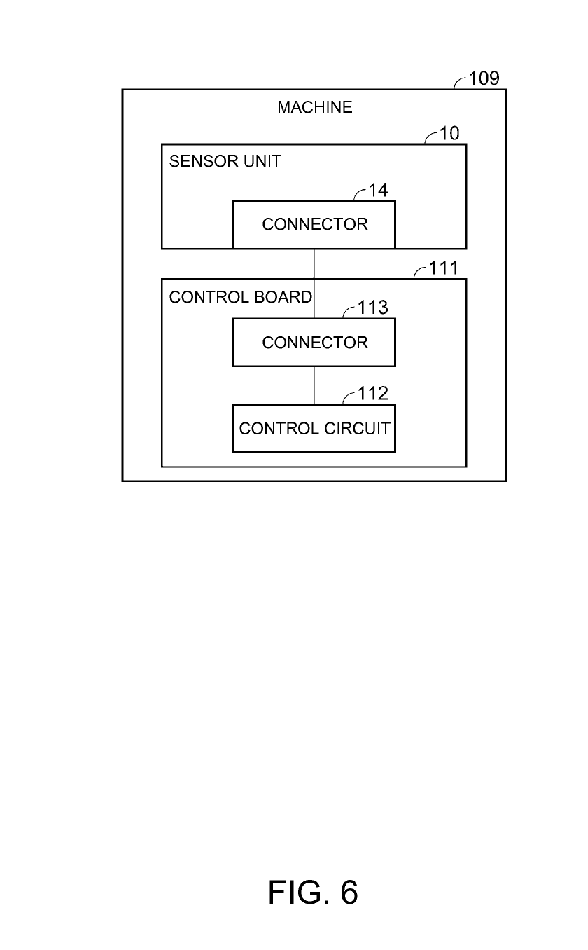

The sensor unit 10 can be used, for example, as a component incorporated in a machine 109, as shown in FIG. 6. In the machine 109, for example, a control circuit 112 and a connector 113 are implemented on a control board (implementation substrate) 111. The connector 14 of the sensor unit 10, for example, can be coupled to the connector 113. A detection signal from the sensor unit 10 can be supplied to the control circuit 112. The control circuit 112 can process the detection signal from the sensor unit 10 and control the action of the machine 109 in accordance with a result of the processing. Examples of the control may include vibration control and action control of an industrial machine and motion control of a robot.

Embodiments of the invention have been described above in detail, but those skilled in the art may easily understand that many variations are conceivable to the extent that they do not substantially depart from the novel items and effects of the invention. Such variations therefore all fall within the scope of the invention. For example, a term described at least once in the specification or the drawings with a different term having a broader meaning or the same meaning can be replaced with the different term anywhere in the specification or the drawings. Further, the configuration and action of each of the sensor unit 10, the substrate 11, the first sensor device 23, the second sensor device 18, the electronic parts 15 and other components are not limited to those described in the embodiment of the invention, and a variety of changes can be made thereto.

The entire disclosure of Japanese Patent Application No. 2013-166008, filed Aug. 9, 2013 is expressly incorporated by reference herein.

What is claimed is:

1. A sensor unit comprising:
a substrate provided with an inertia sensor and a connector connected to the inertia sensor; and
a mount on which the substrate is placed and which includes an opening through which the connector is exposed,
wherein a gap is provided between the substrate and the mount, and
the inertia sensor is provided in a position that falls within the gap in a plan view.

2. The sensor unit according to claim 1,
wherein the substrate has a mount-joint area that is boned to the mount and a non-mount-joint area that overlaps with the gap in a plan view, and
the inertia sensor is disposed in the non-mount-joint area.

3. The sensor unit according to claim 1,
wherein the mount-joint area of the substrate is provided in a portion around the opening.

4. The sensor unit according to claim 1,
wherein a filler is provided in a portion between an outer circumferential portion of the connector and a circumferential edge of the opening.

5. The sensor unit according to claim 1,
wherein an input/output surface of the connector is positioned inside the mount.

6. The sensor unit according to claim 1,
further comprising a lid member,
wherein the lid member is connected to the mount.

7. An electronic apparatus comprising the sensor unit according to claim 1.

8. A moving object comprising the sensor unit according to claim 1.
